(19) United States
(12) Patent Application Publication
(10) Pub. No.: US 2003/0103625 A1
(43) Pub. Date: Jun. 5, 2003

(54) Method for Calculating Cryptographic Key Check Data

(76) Inventors: David Naccache, Paris (FR); Nora Dabbous, Bologne (IT)

Correspondence Address: BURNS DOANE SWECKER & MATHIS L L P, POST OFFICE BOX 1404, ALEXANDRIA, VA, 22313-1404, US

(21) Appl. No.: 10/257,130

(22) PCT Filed: Apr. 18, 2001
(86) PCT No.: PCT/FR01/01194

(30) Foreign Application Priority Data
Apr. 25, 2000 (FR) 00 05254

(51) Int. Cl. H04K 1/00

(52) U.S. Cl. 380/29

(57) ABSTRACT

The invention concerns a method for calculating a control datum of a secret key algorithm with N bits, including N-N/n random and encryption bits and N/n checksum bits. The invention is characterised in that it comprises the following steps: encrypting a specific message of K bits using N/n encryption bits of the key; constructing a control datum by selecting N/n bits among the K bits of the encrypted message; integrating one of the N/n bits of said control datum in all the n-1 encryption bits so as to constitute a complete secret key of N bits. The invention is particularly applicable to the data encryption standard (DES), the control datum being constructed from a constant message.

The invention concerns a method for calculating check data for a secret key cryptographic algorithm. Such check data is mainly used within the context of the DES (Data Encryption Standard) algorithm; it is then known by the term “checksum” and consists of attaching redundant specific values to the secret key. The method according to the invention is based on calculating check data from a specific (known and preferentially constant) message. In the remainder of the text, the usual term checksum will be used to designate this check data.

The present invention concerns more specifically the DES algorithm which is in fact the only secret key algorithm known at present which uses a checksum calculation, the object of the invention.

The DES is one of the best known and most used secret key cryptographic algorithms. Such an algorithm is said to be symmetrical since it makes use of a single 64-bit key, which is secret and reversible, for encrypting and decrypting data.

More specifically, the DES has a key of 64 secret bits, of which 56 are random encryption (and decryption) bits and 8 are checksum bits. During operation, the DES generates 16 subkeys of 48 bits from the 56 random bits. Thus, in each of the 8 octets of the DES key, the first 7 are random and used for calculating the subkeys, and the last bit forms part of the checksum. In general, the bits of this checksum are parity bits, that is to say they are calculated by an Exclusive-OR operation on the first 7 bits of each octet.

The checksum is mainly used for protecting the DES key against memory attacks or DFAs (Differential Fault Attacks) which consist of modifying, one by one, the bits of the key in order to attempt to determine it. For example, the bits at 1 are forced to 0, one by one, and the DES is used with these modifications to encrypt the same message until all the bits of the key are at zero (the encrypted message is then constant). The procedure then continues by going back up the chain of encrypted messages and success can thus be achieved in determining which were the bits at 1 in the initial key.

The checksum makes it possible to avoid such attacks. This is because the checksum (conventionally composed of parity bits) can be recalculated regularly and thus a modification of one or more of the bits of the key can be detected.

On the other hand, knowledge of the checksum can allow information on the encryption bits of the key to be filtered, by revealing whether the number of bits at 1 is even or odd in each octet.

The objective of the present invention is to solve this drawback and propose a method of calculating a checksum which discloses no information about the secret bits of the key.

To that end, the method proposes constructing a checksum from a specific message, encoded using only the encryption bits of the key, and integrating the bits of this checksum into the encryption bits of the key in order to reconstitute a complete key. The algorithm will then be used according to a conventional operation with a key consisting of random encryption bits and this constructed checksum.

A more particular object of the invention is a method of calculating check data for an algorithm with a secret key of N bits, of which N-N/n are random encryption bits and N/n are check data bits, characterised in that it has the following steps:

encrypting a specific message of K bits using the N-N/n encryption bits of the key;

constructing check data by selecting N/n bits from among the K bits of the encrypted message;

integrating one of the N/n bits of said check data every n-1 encryption bits of the key so as to constitute a complete secret key of N bits.

According to one characteristic, the specific message is a constant message.

According to one specific feature, the K input bits of the constant message have the same value.

According to another characteristic, the check data consist of the first N/n bits of the encrypted message.

According to one characteristic, K is equal to N.

According to one preferential application, the secret key algorithm is the DES, said key having 64 bits, of which 56 are encryption bits and 8 are check data bits.

According to one characteristic, the secret key algorithm being implemented in an electronic component, the construction of the check data is performed only once per key, at the time of manufacture of the electronic component or upon first use of the electronic component with a given key.

According to one characteristic, the method also consists of verifying the integrity of the complete secret key by comparing recalculated check data, from the same specific message, with the constructed check data.

According to one characteristic, verification of the check data is carried out each time the electronic component is powered up.

According to another characteristic, verification of the check data is carried out before each call to the algorithm.

According to one characteristic, when the check data verification is erroneous, the method has a function of inhibiting the algorithm with the constructed secret key and/or a function of inhibiting the electronic component.

The invention is applicable to any secure medium, of smart card type, or to any calculating device, of the type of a computer provided with encryption software, having an electronic component capable of implementing the method according to the invention.

The method according to the invention makes it possible to construct a checksum which reveals no information about the secret key with which it is associated. This is because the checksum is no longer in any way linked to the parity of the encryption bits of the key.

Moreover, as this checksum contains no sensitive information, it is not even necessary to conceal it.

The security of the key nevertheless remains certain since the verification that no attack has been instituted remains, by calculating a new checksum and comparing it with the checksum constructed initially.

The method according to the invention requires a first operation of the algorithm with only the encryption bits of the key, so as to recalculate the checksum for verification, which represents a time cost. However, this time cost is compensated for by the gain in security provided by the method according to the invention.

Other specific features and advantages of the invention will emerge clearly from a reading of the description which is produced below and which is given by way of an illustrative and non-limitative example.

The description refers to a DES algorithm with a secret key of 64 bits. This is because, among the algorithms known at present, only the DES uses a checksum for countering DFA type memory attacks. Nevertheless, the method according to the invention could be applied to other symmetrical algorithms using secret, possibly longer, keys.

The object of the invention is to construct a checksum which reveals no information about the 56 encryption bits of the DES key.

To that end, a specific message M of K bits, that is to say not kept secret, is encoded by the 56 encryption bits of the DES. According to one preferential embodiment, a message M of 64 constant, that is to say fixed and known, bits is chosen. According to one embodiment, the message M can consist of K bits all having the same value, for example all at 0. The encrypted message M′ at the output of the DES has K bits (64 in the example) which disclose absolutely nothing about the 56 encryption bits used by the algorithm.

The invention then consists of selecting 8 bits from among the 64 bits of the encrypted message M′. Any bits whatsoever can be selected but, for simplification, the first 8, that is to say the first octet of the encrypted text M′, are preferentially chosen. These 8 bits then form the DES checksum Co.

The bits of this constructed checksum Co are next integrated into the 56 random encryption bits in order to form a complete key of 64 bits. Each bit of the checksum is placed between the encryption bits every 7 bits.

The checksum Co thus constructed is done so once and for all for a given key, either at the end of production at the time of manufacture of the electronic component on which the DES is implemented, or upon first use of said component with this key. There are in fact applications in which the DES key can be modified, and a new construction of the checksum Co is then necessary.

Subsequently, the DES resumes conventional operation, that is to say it codes and decodes messages with a key of 64 bits of which 56 are random and 8 are a checksum containing strictly no information about said encryption bits.

However, protection against possible DFA type memory attacks remains certain by recalculating a checksum C₁ and comparing it with the constructed one Co, for example each time the component is powered up, or before each call to the DES.

The verification checksum C₁ is calculated with the 56 encryption bits of the key from the initial constant message M, and determined by 8 of the bits of the message thus encrypted M′ (the same bits as for Co, the first for example, are used again).

If a DFA attack has been instituted and a bit of the key has been modified, the checksum C₁ calculated with the attacked key from the same initial constant message M will necessarily be different from that constructed initially and stored Co. This is because, as the DES is a non-linear algorithm, many bits of the encrypted message M′ will be modified by the modification of a single bit of the key and the checksum C₁ reconstructed from this attacked key will certainly have bits different from Co.

On the other hand, if C₁=Co, the key has undergone no attack, and it can be used without any concern.

On the contrary, if C₁≠Co, the key has undergone an attack. The method according to the invention then has a function of inhibiting the use of the encryption/decryption algorithm with this constructed complete secret key, and/or a function of inhibiting the use of the electronic component on which the method is installed (for example a smart card).

1. A method of calculating check data for an algorithm with a secret key of N bits, of which N-N/n are random encryption bits and N/n are check data bits, characterised in that it has the following steps:
encrypting a specific message (M) of K bits using the N-N/n encryption bits of the key;
constructing check data (Co) by selecting N/n bits from among the K bits of the encrypted message (M′);
integrating one of the N/n bits of said check data (Co) every n-1 encryption bits so as to constitute a complete secret key of N bits.

2. A method of calculating check data according to claim 1, characterised in that the specific message (M) is a constant message.

3. A method of calculating check data according to claim 2, characterised in that all the input bits of the constant message (M) have the same value.

4. A method of calculating check data according to one of claims 1 to 3, characterised in that the check data (Co) consist of the first N/n bits of the encrypted message (M′).

5. A method of calculating check data according to one of claims 1 to 4, characterised in that K is equal to N.

6. A method of calculating check data according to any one of the preceding claims, characterised in that the secret key algorithm is the DES (Data Encryption Standard), said key having 64 bits, of which 56 are encryption bits and 8 are check data bits.

7. A method of calculating check data according to any one of the preceding claims, the secret key algorithm being implemented in an electronic component, characterised in that the construction of the check data (Co) is performed only once per key.

8. A method according to claim 7, characterised in that the check data (Co) is constructed at the time of manufacture of the electronic component provided with the key.

9. A method according to claim 7, characterised in that the check data (Co) is constructed upon first use of the electronic component with the key.

10. A method of calculating check data according to any one of the preceding claims, characterised in that it also consists of verifying the integrity of the complete secret key by comparing recalculated check data (C₁), from the specific message (M), with the constructed check data (Co).

11. A method according to claim 10, the secret key algorithm being implemented in an electronic component, characterised in that verification of the check data (C₁=Co) is carried out each time the electronic component is powered up.

12. A method according to claim 10, characterised in that verification of the check data (C₁=Co) is carried out before each call to the algorithm.

13. A method according to one of claims 10 to 12, characterised in that it has a function of inhibiting the algorithm with the constructed complete secret key when the check data verification is erroneous (C₁≠Co).

14. A method according to one of claims 10 to 12, the secret key algorithm being implemented in an electronic component, characterised in that the method has a function of inhibiting the use of the component when the check data verification is erroneous (C₁=Co).

15. A secure medium, of smart card type, characterised in that it has an electronic component capable of implementing the method according to claims 1 to 14.

16. A calculating device, of the type of a computer provided with encryption software, characterised in that it has an electronic component capable of implementing the method according to claims 1 to 13.
